(19) United States
(12) Patent Application Publication
(10) Pub. No.: US 2007/0136805 A1
(43) Pub. Date: Jun. 14, 2007

(54) Business-to-business remote network connectivity

(75) Inventors: Stuart Perry, Lake Worth, FL (US); Mihai Voicu, Boca Raton, FL (US); Ovide Mercure, Miramar, FL (US)

Correspondence Address: Bryan H. Opalko, Esquire;Buchanan Ingersoll & Rooney PC, 301 Grant Street, One Oxford Centre, 20th Floor, Pittsburgh, PA, 15219, US

(73) Assignee: ILS Technology LLC, Boca Raton, FL (US)

(21) Appl. No.: 11/603,597

(22) Filed: Nov. 22, 2006

Related U.S. Application Data
(60) Provisional application No. 60/739,752, filed on Nov. 23, 2005.

(51) Int. Cl. G06F 15/16

(52) U.S. Cl. 726/14

(57) ABSTRACT

A system for providing connectivity to employer networks for support personnel and consultants who regularly work at customer locations. A secure network mechanism is provided to connect these users at the customer locations with their respective employer networks for the purpose of accessing e-mail, reference material, specialized application databases at their company, etc. Multiple VPNs are provided for the transmission within a customer location and for transmission to the employer servers to maintain security and control at the customer location and across the Internet connection. The customer location may inspect data and control what leaves their facility, while the consultant employer network is allowed to control user access to their own network. Name server information is also transferred between the disparate networks so that a consultant looking for a common server name in his own employer network gets the correct connection instead of the local customer's server connection.

### CROSS-REFERENCE TO RELATED APPLICATIONS

This application claims the benefit of co-pending provisional patent application Ser. No. 60/739,752 entitled “Business to Business Remote Network Connectivity”, filed on Nov. 23, 2005, the entire disclosure of which is incorporated by reference herein.

This application is related to U.S. patent application Ser. No. 10/385,479 entitled “Diagnostic System and Method for Integrated Remote Tool Access, Data Collection, and Control”, filed Mar. 12, 2003, and also to U.S. patent application Ser. No. 10/385,442 entitled “Data Sharing and Networking System for Integrated Remote Tool Access, Data Collection, and Control”, filed on Mar. 12, 2003, the entire disclosures of which are hereby incorporated by reference herein.

### FIELD OF THE INVENTION

The present invention is directed toward providing connectivity to employer networks for support personnel and consultants who regularly work in customer locations and, more particularly, toward providing such connectivity in a secure manner from both the employer and customer standpoints.

### BACKGROUND OF THE INVENTION

VPN connections are common in the industry and allow users with general Internet access to connect from home networks to their employer networks in a secure fashion. However, Internet connections from within a company, such as a customer facility, are usually are limited for security purposes to a few ports (usually port 80 for HTTP), and will not allow other activity which may be required for a visitor to access mail and other applications in his/her remote employer “home” office. The required VPN access is usually not allowed for vendors, consultants and support personnel from other companies that may be working from within a customer location. If a VPN connection is allowed, it will usually let any data flow from the customer location to the consultant employer network, and is therefore not secure from the customer standpoint.

What is needed then is an improved method of allowing access by visiting personnel at a customer location to their own company intranet in a secure manner that both companies can trust.

The present invention is directed toward overcoming one of more of the above-identified problems.

### SUMMARY OF THE INVENTION

The present invention provides a secure network mechanism to connect the users/consultants at a customer location with their employer network for the purpose of accessing email, reference material, and specialized application databases at their “home” company. Specifically, the present invention allows this network connectivity to take place based on business rules and is logged and controlled by a central system to reduce the possibility of sensitive information being transferred out of a customer location.

The major components of the inventive system are specialized network routers that allow the host company to limit exposure to external threats while allowing regular visitors access to their employer intranets. This is achieved by using a set of router/VPN servers that appropriately route traffic while maintaining network name server capabilities across the networks. A main component of the present invention is the ability to control the router systems via a central system resulting in a dynamic access network which is controlled based on conditions at the time.

It is an object of the present invention to provide secure connectivity to employer networks for support personnel and consultants who regularly work in customer locations.

It is a further object of the present invention to provide providing such connectivity in a secure manner from both the employer and customer standpoints.

It is yet a further object of the present invention to provide secure connectivity which will allow the host company to limit exposure to external threats while allowing regular visitors access to their employer intranets.

Other objects, aspects and advantages of the present invention can be obtained from a study of the specification, the drawings, and the appended claims.

### BRIEF DESCRIPTION OF THE DRAWINGS

The foregoing and other features and advantages of the present invention will be apparent from the following, more particular description of a preferred embodiment of the invention, as illustrated in the accompanying drawings wherein like reference numbers generally indicate identical, functionally similar, and/or structurally similar elements.

FIG. 1 depicts a standard web access network configuration;

FIG. 2 depicts a standard VPN connection between businesses;

FIG. 3 depicts the inventive business to business connectivity invention with the traffic controller hub according to one embodiment of the present invention;

FIG. 4 depicts a flow interaction diagram of the components of the present invention;

FIG. 5 depicts an architectural diagram of system and component interaction in accordance with the present invention;

FIG. 6 depicts an architectural diagram of a client workstation connected in three different customer environments in accordance with the present invention;

FIG. 7 depicts full implementation of the inventive system with multiple users; and

FIG. 8 depicts the invention system with added control of VPN connections in accordance with another embodiment of the present invention.

### DETAILED DESCRIPTION OF THE INVENTION

As used herein, the following terms shall have the following meanings:

“Customer”: A customer is a specific business facility. Other suppliers may be in this location and attached to this network, even though they are not employees of a customer.

“Consultant”: An employee of a business other than a customer who needs to be in a customer facility but also needs to have access to their own employer's network and applications.

“Authentication”: The process that identifies a person (a common method is user ID and password).

“Authorization”: The process that determines what a person is allowed to do, such as transfer files.

“DHCP”: Dynamic Host Configuration Protocol. A methodology where a network address is dynamically assigned to a computer when it is plugged into a network.

“DNS Name”: A fully qualified hostname that includes the domain (e.g., “mailman.ilstechnology.com”).

“eCentre”: An application that is used for secure collaboration. In this context, it is a sample application that can be used with the present invention to provide other .

“Host Name Resolution Table”: A list of computer addresses and their names for the purpose of identifying the physical IP associated with the host name. This is common in standard networks, but even more critical for systems used in multiple networks to resolve the correct system in the correct network.

“Internet Protocol Address (IP)”: The Internet address of a system (e.g., “192.168.1.19”).

“IPSec”: Standard protocol for secure communication.

“Naming for Systems”: The names and associated addresses of network computers.

“Network Mapping (NATing)”: Methodology used to map network addresses between two different networks.

“Privileges”: Permissions that are set by the administrator to allow or deny users access to services such as a VPN access. By setting access privileges, the administrator controls user access to restricted data.

“ServiceNet”: A particular implementation of a hub based multipoint to multipoint VPN connection service.

“System Network Administrator”: A special type of person who is an employee of the customer facility. The customer system network administrator (or simply network administrator) is responsible for setting up and managing routers, firewalls and their access control lists. The administrator also assigns user passwords and access privileges, and delegates administrative duties where appropriate.

“Virtual Private Network (VPN)”: A connection between a user from outside a business to inside that business in a secure fashion.

Various embodiments of the present invention are discussed in detail below. While specific exemplary embodiments are discussed, it should be understood that this is done for illustration purposes only. A person skilled in the relevant art will recognize that other components and configurations can be used without departing from the spirit and scope of the invention.

Prior Approaches

There are several connectivity options available today for support or consultant personnel who work at customer locations and need to access their home network and systems. There may be other connectivity options that are not described below, but these are some of the most common implementations. For the purpose of example, we assume the consultant has to access both an e-mail system and a specific application server that reside in their employer's network.

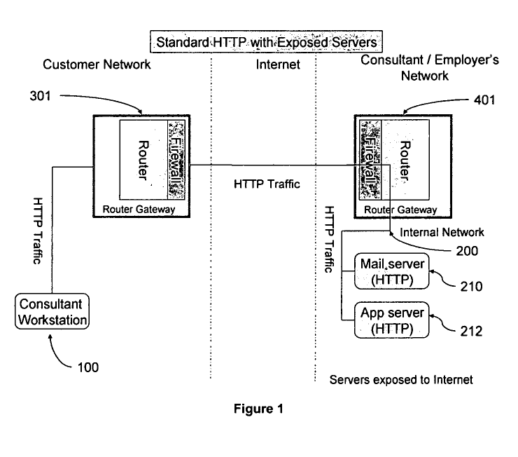

Option 1: Connect to host systems that have been made available on the web. However, this can only be done if the mail system and the application system at the employer network have a user interface that allows web browser access (usually HTTP on port 80). The employer business would also have to make these servers viewable from the Internet rather than being in their local business network, thus exposing them to security issues. FIG. 1 illustrates a standard implementation of such a connection. In this configuration, the consultant would attach their workstation 100 and Internet web browser to the customer network, be routed through the customer gateway 301 to an external Internet connection, and then to the consultant gateway 401 for connection to a host page for their mail 210 or application 212 systems. Issues with this solution include:
1) Companies do not like to expose their internal systems to the Internet.
2) Many applications do not have a web browser interface that could be used for this approach.
3) The company must obtain a public IP for use on the Internet.

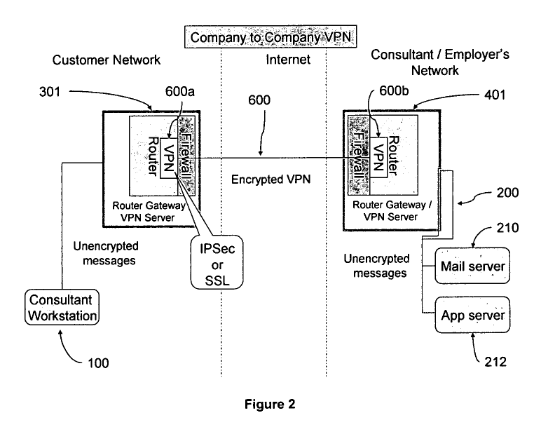

Option 2a: Another common option is to create a standard site-to-site VPN connection as shown in FIG. 2. In this case, both businesses configure their firewalls with VPN 600a in the customer gateway 301 and with VPN 600b in the consultant gateway 401 to allow a direct business-to-business VPN 600 connection between the two business networks to allow the consultants to access their employer business network and the related applications. However, there are problems associated with this implementation, which include:
1) The control is at the port level only. There is no content control over the traffic in a VPN; in other words, any communication can take place. This is less secure for each party.
2) Requires a separate VPN connection or port for each partner. It is optimized for a single connection and must have multiple instances of it for multiple consultant and vendor partners. This can be difficult to manage on a person by person basis.
3) There may be IP address conflicts between the customer network and the consultant home network. There is no mechanism for DNS resolution between the sites. Applications would need to be reconfigured to access their employer systems.
4) The consultant employer site would be allowing in anyone connected in their customer network that could provide a valid password.
5) The consultant is typically connected using DHCP addressing, which makes the user system anonymous. If the system is configured with fixed IP addresses, it will not work at multiple customer locations (they won't all assign the same address in their network as they have different subnet address schemes).

Option 2b: In this case, companies could use the site-to-site VPN connection described in Option 2a above, and limit it further to allow access between a limited set of system addresses or IPs. This reduces the exposure to a limited number of systems, in theory, but users can still use the original connection to telnet to another system and gain access to other systems that were not originally intended for access.

What is therefore needed is an alternative solution, such as the inventive business-to-business remote network connectivity system described herein, which creates an environment that mimics a standard VPN connection for the end user, but also provides two key improvements: 1) better security through control of activities and inspection of each data packet; and 2) a host name resolution table to the client so naming issues are resolved transparently, and also allows multiple networks with the same subnet naming scheme (i.e., “192.168.1.x”) to interact without specialized address natting.

Inventive Business-to-Business Connection

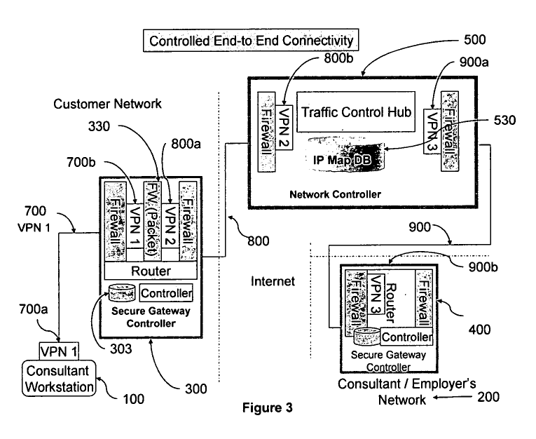

As shown in FIG. 3, the business-to-business network connectivity system of the present invention has components to allow a standard VPN connection between businesses. It also contains additional hardware (“HW”) and software (“SW”)which are installed in line with the VPN to provide additional dynamic control of the system. It utilizes a set of VPNs which are linked together in the overall flow, so that there is better control.

The consultant still connects his/her workstation 100 to the customer network and, specifically, connects to an extended customer secure gateway controller 300. In the present invention, there are now multiple VPNs 700, 800 and 900 created that provide for end to end security and inspection of packet detail. These actions are controlled by the traffic control hub 500 and extended with the IP map DB 530 domain name mapping information.

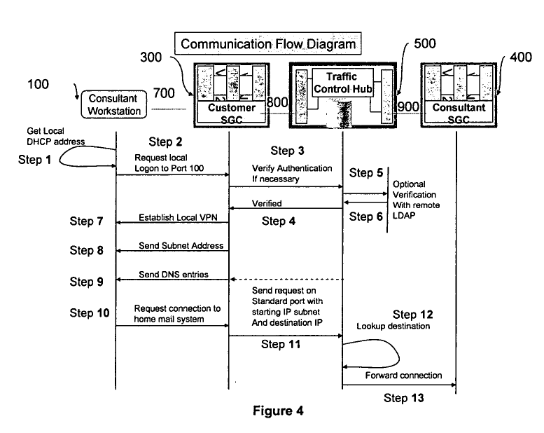

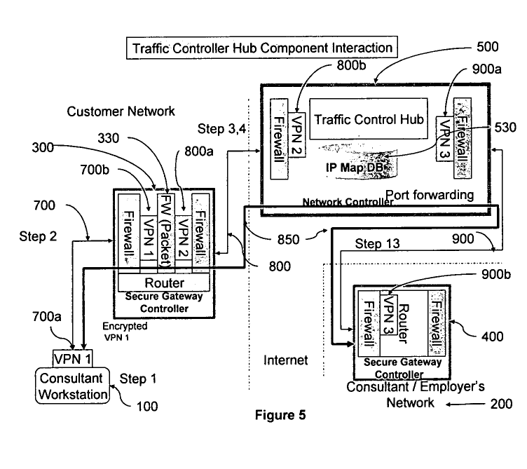

The VPN2 connection 800 used in step 4 (see FIGS. 4-5) and VPN3 connection 900 used in step 6 (see FIGS. 4-5) are setup during the original installation and configuration of the traffic control hub 500 and the customer VPN server 300 and the consultant VPN server 400.

FIG. 4 shows the flow diagram to connect and set up the consultant's workstation 100. In step 1, the consultant plugs his/her workstation 100 into the customer network 300 and a networking IP address is assigned to him/her via DHCP. In this example, the networking IP address may be “192.168.1.22”. Also, as part of the normal DHCP operation, the workstation 100 is assigned a local DNS (Domain Name Server) on the customer network to provide name resolution. As part of the invention is subsequent steps, a second method for domain name resolution is added (i.e., name resolution table) to the workstation 100 that will allow the consultant workstation 100 to resolve or route back to systems on their home employer network.

In step 2, the consultant starts his/her part of the VPN 700a (see FIG. 3) which connects to the local customer secure gateway controller 300 and VPN 700b (see FIG. 3). As part of the connection process, the consultant's client workstation 100 presents a certificate and the consultant enters a password, and the request is made to the customer secure gateway controller 300 on a particular port. These pieces of information can be transferred to the traffic control hub 500, in step 3, which verifies them based on local lists and certificates; the consultant user information may be checked with an external server for user verification, as shown in steps 5 and 6. The verification is returned to the workstation 100 in step 7, and completes the required steps to establish VPN1 700.

Then, in steps 8 and 9, additional data is transferred from the secure gateway controller 300 to the consultant workstation 100. This data is the newly assigned subnet address, such as “10.10.20.22” and the required name resolution table entries that allow the consultant workstation 100 to request to connect to a server referred to by a fully qualified domain name such as, for example, “mail.ilstechnology.com”,and get the correct server in his/her home network, as opposed to a server which may have the same name in the customer network. The subnet address in its general form is denoted by “10.10.20.x”,where “10.10.20” defines the subnet and the “x” portion denotes the particular workstation 100. Multiple workstations, having different subnet addresses, may thus use the same subnet. Typically, the subnet will be unique to the consultant employer, such that consultants from the same employer will use the same subnet regardless of the customer location at which they are located. However, one skilled in the art will appreciate that the inventive system will still be fully operational even if the subnets are not unique to the various consultant employers.

In step 8, the secure gateway controller 300 assigns a logical new address on a particular subnet to that consultant workstation 100. In essence, a virtual “tunnel” is created for the transfer of information. This new address subnet can be associated with the vendor name of the consultant. In this example, the secondary address of the workstation 100 (for within the VPN environment) may be “10.10.20.22”. This subnet address can be fixed for a particular user consultant so that the always get this address no matter which customer location they start from. This would allow them to gain access to applications that may have restrictions by IP address. In this example, the “192.168.1.22” address that was originally assigned by the customer's DHCP remains unchanged. The consultant workstation 100 now has two DNS references, one for the customer network and one for the home employer network.

In step 9, a secondary method for domain name resolution is established by creating a local name resolution table for the consultant from the traffic control hub 500 back through the customer secure gateway controller 300 and then on to the consultant workstation 100. The name server definitions from the traffic control hub 500 are added to the consultant workstation 100. The consultant application server names and related addresses (IPs) on the workstation 100 which are configured to point to the consultant employer's network remain unchanged and will be automatically routed through the combination of tunnels to the employer's network. A copy of the name resolution table is maintained on the customer secure gateway controller 300, so that they can be sent directly from the controller 300 to the consultant workstation 100 without making a request to the traffic control hub 500. These local copies can be updated at regular intervals or based on changes.

An alternate method is to add a secondary domain name server entry at the workstation 100 which points to a server on the employer network.

In step 10, the consultant workstation 100 makes a request to connect to a home mail system. This request goes through the VPN1 tunnel 700 (see FIG. 3) to the customer secure gateway controller 300 which, in step 11, passes the request through VPN2 tunnel 800 (see FIG. 3) to the traffic control hub 500.

In step 11, another VPN2 800 is utilized, this time from the customer secure gateway controller 300 to the central traffic control hub 500. All traffic from a particular customer site is routed to the same port on the traffic control hub 500, so that the destination environment is well understood. During the initial start-up of the customer secure gateway controller 300, the controller 300 passes x509 Certs to establish its identity to the hub 500. The traffic control hub 500 responds to the request and establishes the second VPN2 800 in the communication chain. This creates the VPN2 800 tunnel which is used whenever another consultant workstation 100 requests external access.

The traffic control hub 500 looks up the destination information, in step 12, in a local table and forwards the information, in step 13, down the VPN3 tunnel 900 (see FIG. 3) to the consultant employer secure gateway controller 400 and on to the local network systems.

In step 13, using the pre-established tunnels from the traffic control hub 500, a third VPN3 900 connection is used. Based on the information that originally came from the customer secure gateway controller 300 (port number of original connection and the subnet (e.g., “10.10.20.x”) assigned to the workstation 100), the traffic control hub 500 is able to determine that the connection was from a particular vendor or consultant company, and all the traffic is thus routed to the appropriate consultant employer gateway controller 400. There is now secure end to end connectivity of the parties. Each consultant company may be assigned a separate port on the traffic control hub 500 so that additional control measures can be used as necessary to separate access.

During operation, customers and consultant companies can take advantage of the chain of VPNs 700, 800 and 900, as shown in FIG. 5, to insert their own security policies. The first VPN1 700 is terminated in the local router or customer secure gateway controller 300 so that the customer can have control over the information that leaves their facility. A custom firewall 330 is employed in the customer secure gateway controller 300 to inspect data packets and make sure only acceptable traffic is allowed to flow through. Unlike traditional firewalls, the custom firewall 330 can change ports/connections without disrupting other user's existing connections. A logical connection 850 is maintained from the consultant workstation 100 to the traffic control hub 500 and then to their home system, while the customer can run applications to inspect packets in the secure gateway controller 300

For the traffic control hub 500 to function properly, the following information is maintained and used from the IP map DB 530. There are a set of tables which map a particular customer subnet and port number on the inside of the customer secure gateway controller 300 to a particular vendor IP and port number on the outgoing side of the traffic control hub 500. The combination of IP addresses and specific ports provide information about who is trying to connect (i.e., which consultant). There is also a set of DNS tables that are specified by each employer as they are defined in the system. The employers provide a list of servers, such as the mail server 210 or application server 212, which their consultants would normally access from a customer site. These are stored in the IP map DB 530 on the traffic control hub 500 for sharing with the local customer secure gateway controller 300. When a consultant workstation 100 requests a connection to the secure gateway controller 300, this secondary DNS information is provided back to the workstation 100.

This means that the workstation 100 has two DNS tables, one provided to it at the original network connection with the DHCP addressing and one provided to it from the VPN1 700 connection. The DNS entry from the VPN1 700 connection is stored in local memory associated with that network address until that VPN1 700 connection is no longer available.

Generally, the customer secure gateway controller 300 will have multiple ports facing the “inside” customer network, with each vendor/consultant company having a dedicated port. For example, consultants or vendors from Company A will always access the customer secure gateway controller 300 via the same dedicated port. Multiple consultants/vendors can utilize the ports concurrently. By assigning each port to a different vendor/consultant company, the customer can manage an entire set of vendor VPN connections with a single customer secure gateway controller 300.

For the customer secure gateway controller 300 to function properly, the following information is maintained and used. Consultants from a particular company all use the same incoming port for their connection to the customer secure gateway controller 300. There is a separate port for each consultant company so that the correct mapping of their home consultant employer network can be provided back to them. On the “outbound” side of the secure gateway controller 300, there is a single port to the traffic control hub 500 allowing for easier management of tunnels where the outbound traffic can share the same tunnel. The traffic on this single tunnel is identified by the combination of subnet address (assigned based on the original port connection to the customer secure gateway controller 300) and incoming port. These are looked up in the network routing table at the traffic control hub 500 for delivery to the correct location.

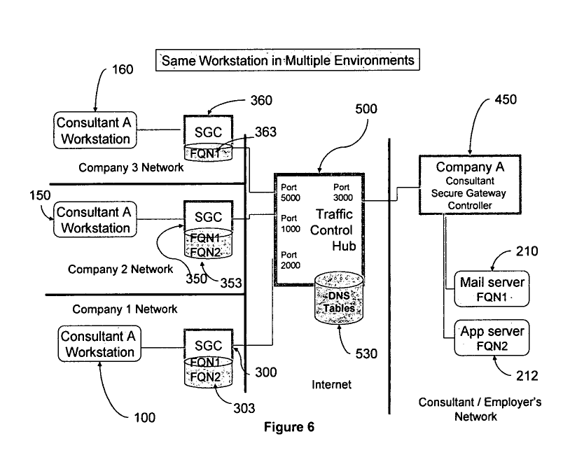

FIG. 6 shows an example of a consultant workstation connected at three different times in three different locations with no changes to the consultant workstation. In this example, the workstations 100, 150 and 160 are all the same workstation, but identified by different reference numbers for ease of reference since they are at different customer locations.

In the case of workstation 100, the consultant is at Company 1 connected to their secure gateway controller 300, and has a DNS entry that allows him to route to his/her employer mail server 210 and/or application server 212 at his/her employer network with no changes to the local workstation (other than what is done automatically by the present invention). In the case of workstation 150, the same workstation is now connected to the Customer 2 network and to their secure gateway controller 350, and can also make connections to his/her employer mail server 210 and/or application server 212 at his/her employer network with no changes. Similarly, workstation 160 is connected to the secure gateway controller 360 at Customer 3 and routed back to his/her mail server 210 at his/her employer network. Based on the rules allowed by each customer, however, a different set of access rights may be allowed or denied.

In each case, a secondary Domain Name Server (DNS) has been provided to the consultant workstations 100, 150, 160. However, the customer has control of the contents of this new DNS system. In the case of Customers 1 and 2, they have allowed both systems (mail 210 and application 212) at the consultant employer's network to be reachable by allowing their respective DNS 303 and 353 to contain all the requested entries for fully qualified domain names. However, in the case of Customer 3, they have limited their allowed DNS 363 to contain only a single entry of the fully qualified domain name of the mail 210 to be accessible. Therefore, the customers have secure control over what is allowed to happen in their network.

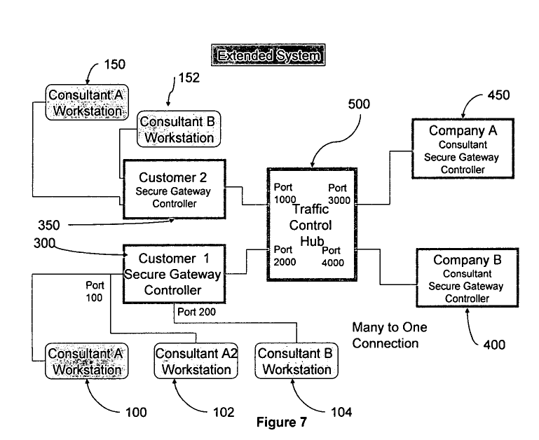

As shown in FIG. 7, the present invention allows an extended architecture of multiple connections of consultant workstations 100, 102, 150, 152 at different customer locations. At Customer 1, two consultant workstations 100 and 102 from company A each connect to the same port 100 on the customer secure gateway controller 300. They are each assigned the same subnet, for example, “10.10.20.x”,and can connect back to their home controller 450 in the company A network. While the consultant workstations 100,102 are assigned the same subnet, they will be assigned different subnet addresses. For example, consultant workstation 100 may be assigned subnet address “10.10.20.20”,while consultant workstation 102 may be assigned subnet address “10.10.20.21”.The two consultant workstations 100 and 102 may be prevented from exchanging information with each other on the assigned subnet; however, the inventive could be set up to allow such an exchange of information between workstations from the same company. A third consultant workstation 104 from company B could also connect to the same customer secure gateway controller 300, but as consultant workstation 104 is from a different company, it would connect on a different port, for example, port 200, on the customer secure gateway controller 300 and receive a different subnet, for example, “10.20.20.x”, with a different subnet address, for example, “10.20.20.22”.

Similarly, consultant workstation 150 (from company A) at Customer 2, will connect to a dedicated port on Customer 2's secure gateway controller 350, with consultant workstation 152 (from company B) at Customer 2 connecting to a different dedicated port on Customer 2's secure gateway controller 350.

Each customer secure gateway controller 300, 350 will have a separate port on which to connect to the traffic control hub 500. For example, as shown in FIG. 7, the secure gateway controller 300 at Customer 1 connects to the traffic control hub 500 at port 2000, while the secure gateway controller 350 at Customer 2 connects to the traffic control hub 500 at port 1000. This keeps the communication streams separate and allows for a mapping of a subnet to a particular consultant employer gateway controller 400, 450.

Additionally, each employer gateway controller connects to a dedicated ports on the outbound side of the traffic control hub 500. For example, company B's gateway controller 400 connects to port 4000, while company A's gateway controller 450 connects to port 3000. This also helps to keep communication streams separate and allows for mapping of the subnets.

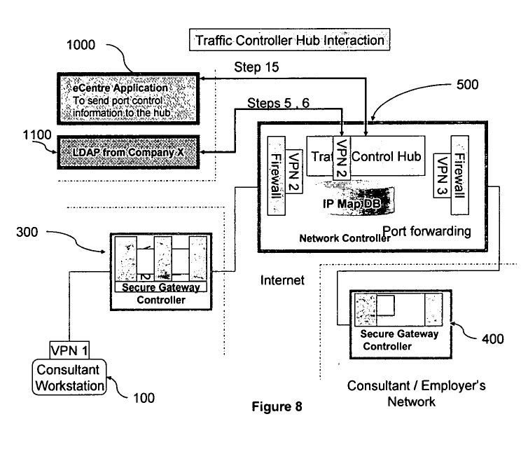

An added feature of the inventive solution is that the customer secure gateway controller 300 can be altered programmatically. Based on this feature, it can be combined with the features of other products, such as eCentre 1000, to further control the overall solution so that accessibility may be based on business rules. For example, the time of access might be limited, or access granted only if there was an approval or only if a certain condition happened in another application. This communication is shown in FIG. 8, step 15, from a controlling application 1000 to the traffic control hub 500. In this example, the controlling application 1000 is the eCentre product, but those skilled in the art will recognize that alternate control applications could be utilized in its place.

In a similar fashion, the customer gateway controller 300 can be linked to external applications 1100, such as a company's LDAP user management system. In this way, the original user certification and password presented by the consultant workstation 100 to the customer secure gateway controller 300 may be passed, via the traffic control hub 500, to an external program 1100 for verification of the user consultant. In this manner, each consultant can present a certificate from a certificate authority used by their company such as, but not limited to, Verisign, Thawte, Self signed certs, etc.

Some of the benefits and features of the present invention are:
Provides the ability to dynamically change status of VPNs through administrator input or programmatic input.
Provides the ability to give a client a Host Name Resolution Table to remove confusion where there are DNS names or IP addresses that are similar in the two separate business networks, for example, “mailman.customer.com” and “mailman.consultant.com”. In the case of a more common WINS resolution, those two servers would have the same name: “mailman”.
The consultant's client application does not have to be reconfigured, no matter where he/she goes (customer or home networks).
Can run over the standard Internet or IPSec connections.
Requires only a single port connection at the customer site to handle access for multiple consultants and partners.
A further extension to the inventive system is to use it in conjunction with a “ServiceNet” (see U.S. Ser. No. 10/385,442) connection to make overall between multiple sites much easier.
Provides the ability for a customer to connect to and effectively manage large numbers of consultant connections.
Allows the consultant to be assigned a “fixed” IP address over the secure connection so that any applications that limit access by IP address will still work.
Provides programmatic control over the central traffic hub so that connectivity rules may be changed depending on the varying conditions.
Provides a custom firewall at the customer level to allow customers to monitor the outbound traffic for on-site consultants. The firewall can be dynamically modified without affecting existing connections.

While various embodiments of the present invention have been described above, it should be understood that they have been presented by way of example only, and not limitation. For example, the terms “consultant”, “vendor”,“customer” and “employer” are used herein and in the claims for point of reference only. The present invention is designed to provide secure communication between any two networks via the VPN connections and the traffic controller hub. Thus, the breadth and scope of the present invention should not be limited by any of the above-described exemplary embodiments, but should instead be defined only in accordance with the following claims and their equivalents.

While the present invention has been described with particular reference to the drawings, it should be understood that various modifications could be made without departing from the spirit and scope of the present invention.

The following set of claims is not limiting, but is merely exemplary of preferred aspects of the present invention. It is to be understood that the present patent application instead covers all aspects of the present invention as shown and described herein.

We claim:

1. A network connectivity system comprising:
a customer gateway controller provided within a customer network, the customer gateway controller connectible to a consultant workstation via a first VPN connection;
a traffic control hub provided within an external network, the traffic control hub connectible to the customer gateway controller via a second VPN connection;
a consultant employer gateway controller provided within a consultant employer network, the consultant employer gateway controller connectible to the traffic control hub via a third VPN connection,
wherein secure communication is established between the consultant workstation and its corresponding consultant employer network via the first through third VPN connections and the traffic control hub.

2. The network connectivity system of claim 1, wherein the customer gateway controller includes multiple input ports, with each port dedicated to a particular consultant employer, such that all consultant workstations of a particular consultant employer connect to the customer gateway controller via the same port.

3. The network connectivity system of claim 2, wherein the traffic control hub includes multiple input ports, with each port dedicated to a particular customer, such that all traffic from a particular customer is routed to the same input port on the traffic control hub.

4. The network connectivity system of claim 3, wherein the traffic control hub receives information on the input port used by the consultant workstation at the customer gateway controller and, based on that information, routes traffic to the appropriate employer network.

5. The network connectivity system of claim 1, wherein the consultant employer gateway controller receives information identifying the consultant workstation that initiated the connection, wherein the consultant employer grants the consultant workstation access to databases and applications in the consultant employer network based on privilege rules associated with the consultant workstation.

6. The network connectivity system of claim 1, wherein the traffic control hub includes multiple output ports, with each port dedicated to a particular consultant employer, such that all traffic to a particular consultant employer is routed from the same output port on the traffic control hub.

7. The network connectivity system of claim 1, wherein the consultant workstation is authenticated by the customer gateway controller to establish the first VPN connection.

8. The network connectivity system of claim 1, further comprising a software application connected to the traffic control hub, wherein the software application controls traffic flow between the consultant workstation and the consultant employer gateway controller based on business rules.

9. The network connectivity system of claim 8, wherein the consultant workstation is authenticated by the software application to establish the first VPN connection.

10. The network connectivity system of claim 1, wherein the consultant workstation is authenticated by an LDAP connected to the traffic control hub to establish the first VPN connection, wherein the LDAP is associated with the consultant employer network.

11. The network connectivity system of claim 1, wherein the customer gateway controller included a firewall provided between the first and second VPN connections, the firewall inspecting data packets to ensure only authorized data is allowed to pass into and out of the customer network.

12. The network connectivity system of claim 11, wherein the firewall can be controlled to inspect each data packet independently and make a decision on whether or not to pass each data packet based on allowed conditions.

13. The network connectivity system of claim 11, wherein the firewall can be controlled to change ports and/or connections at the customer gateway controller without disrupting existing connections.

14. The network connectivity system of claim 11, wherein the firewall is controllable by an application external to the customer gateway controller to modify conditions for access to/from the customer network.

15. The network connectivity system of claim 1, wherein consultant workstations from the same consultant employer are assigned the same subnet for connection to their consultant employer network.

16. The network connectivity system of claim 15, wherein each consultant workstation has a different subnet address within the same subnet.

17. The network connectivity system of claim 1, wherein the consultant workstation is authenticated to establish the first VPN connection, and wherein upon authentication the consultant workstation receives a domain name server entry from the traffic control hub which points to a server on the consultant employer network.
